(19) United States
(12) Patent Application Publication
(10) Pub. No.: US 2009/0325548 A1
(43) Pub. Date: Dec. 31, 2009

(54) METHOD AND APPARATUS FOR PROVIDING NETWORK OUTPUT SERVICE BY USING MOBILE COMMUNICATION DEVICE

(75) Inventor: Kyung-hoon KIM, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/365,191

(22) Filed: Feb. 4, 2009

(30) Foreign Application Priority Data
Jun. 25, 2008 (KR) 10-2008-0060224

(51) Int. Cl. H04M 3/42

(52) U.S. Cl. 455/414.1

(57) ABSTRACT

A method and an apparatus for providing an output service by using a mobile communication device through a network are provided. The method of providing a network output service, includes: receiving network identification address information of reproduction service information selected by a mobile communication device, based on an output request of the mobile communication device; requesting to provide output information corresponding to reproduction service information based on the network identification address information of the reproduction service information; receiving output information including the reproduction service information and additional service information; and providing output service information including a combination of the reproduction service information and the additional service information, based on the output information.

### CROSS-REFERENCE TO RELATED PATENT APPLICATIONS

This application claims priority from Korean Patent Application No. 10-2008-0060224, filed on Jun. 25, 2008, in the Korean Intellectual Property Office, the disclosures of which are incorporated herein in its entirety by reference.

### BACKGROUND OF THE INVENTION

1. Field of the Invention

Methods and apparatuses consistent with the present invention relate to a network output service, and more particularly, to an output service provided by network communication using a mobile communication device.

2. Description of the Related Art

As Internet technology is introduced into various electronic products, Internet use on wireless mobile communication devices is increasing, and in particular, Internet searches are popular. Additionally, as web searches are available in various electronic products such as computers or TVs, information can be obtained through web sites. When wireless mobile communication devices access the Internet, they can perform wireless information communication with other networked devices through a network. However, the size of wireless mobile communication devices is relatively large and a network environment is limited. Thus, wireless mobile communication devices cannot communicate a large amount of data at one time.

### SUMMARY OF THE INVENTION

The present invention provides a method and an apparatus for providing a network output service by using a mobile communication device, whereby an output service including information to be provided to a user and additional information is provided to the user by using the mobile communication device.

According to an aspect of the present invention, there is provided a method of providing a network output service of a network device, the method including: receiving network identification address information of reproduction service information selected by a mobile communication device, based on an output request of the mobile communication device; requesting to provide output information of the reproduction service information based on the network identification address information of the reproduction service information; receiving the output information comprising the reproduction service information and additional service information; and providing output service information comprising a combination of the reproduction service information and the additional service information, based on the output information.

The receiving of network identification address information of reproduction service information may include: inputting an output request to the network device; and receiving network identification address information of the reproduction service information selected by the mobile communication device, wherein the network device is selected from among at least one network device registered in the mobile communication device.

The requesting to provide output information may include requesting to provide output information corresponding to the reproduction service information by accessing a network identification address of the reproduction service information via a network output service provider.

The receiving of output information may include receiving the reproduction service information and the additional service information corresponding to the reproduction service information from the network output service provider.

The receiving of output information may include: receiving reproduction service information and additional service information corresponding to the reproduction service information, and receiving output service information configuration information which indicates a configuration in which the reproduction service information and the additional service information are combined in the output service information.

The providing of output service information may include: generating output service information by combining the received reproduction service information and the additional service information based on the output service information configuration information; and providing the generated output service information.

The mobile communication device may access the network device by using an Internet protocol (IP) address and a media access control (MAC) address of the network device.

The network output service information provider and a reproduction service provider for a mobile communication device may be the same.

The additional service information may be determined based on at least one of an attribute of the reproduction service information, an attribute of a user of the mobile communication device, an attribute of a user of the network device, and an attribute of the network device.

In the receiving of additional service information, the additional service information may include commercial/non-commercial advertising that is provided by a network output service information provider.

According to another aspect of the present invention, there is provided a method of providing a network output service by using a mobile communication device, the method including: selecting at least one network device from a plurality of registered network devices; selecting at least one of a plurality of pieces of received reproduction service information for a mobile communication device; requesting to output information comprising the selected reproduction service information and related additional service information, to the selected network device; and transmitting network identification address information of the selected reproduction service information to the selected network device.

The mobile communication device may access the network device by using an Internet protocol (IP) address and a media access control (MAC) address of the network device.

The requesting to output information may include generating output service information by combining reproduction service information provided by a reproduction service provider for a mobile communication device and additional service information provided by a network output service provider and requesting to output the output service information.

According to another aspect of the present invention, there is provided an apparatus for providing a network output service by using a mobile communication device, the apparatus including: a reproduction service provision unit for a mobile communication device, providing a reproduction service for a mobile communication device to the mobile communication device; an output information provision request input unit to which a request of providing output information corresponding to predetermined reproduction service information of a reproduction service for a mobile communication device selected by the mobile communication device, is input from the network device selected by the mobile communication device; an additional service information determination unit determining additional service information corresponding to the reproduction service information; and an output information provision unit providing output information comprising the reproduction service information and the additional service information to the network device.

A request to provide output information corresponding to reproduction service information may be input to the output information provision request input unit when the network device accesses a network identification address of the predetermined reproduction service information.

The additional service information determination unit may further determine output service configuration information on a configuration in which reproduction service information and additional service information are combined in output service information, and the output information provision unit may provide output information comprising the reproduction service information, the additional service information, and the output service configuration information.

The additional service information determination unit may determine additional service information based on at least one of an attribute of the reproduction service information, an attribute of a user of the mobile communication device, an attribute of a user of the network device, and an attribute of the network device.

In the output information provision unit, a reproduction service provider for a mobile communication device and the network output service information provider may be the same.

The additional service information may include commercial/non-commercial advertising that is provided by a network output service information provider.

According to another aspect of the present invention, there is provided an apparatus for providing an output service of a network device, including: a reproduction service address information receiving unit receiving network identification address information of reproduction service information selected by a mobile communication device, based on an output request of the mobile communication device; an output information provision request unit requesting to provide output information corresponding to the reproduction service information based on the network identification address information of the reproduction service information; an output information receiving unit receiving the output information comprising the reproduction service information and additional service information; and an output service information provision unit providing output service information comprising a combination of the reproduction service information and the additional service information, based on the output information.

The reproduction service address information receiving unit may receive an output request input to at least one network device selected from a plurality of network devices registered in the mobile communication device, and may receive network identification address information of reproduction service information selected by the mobile communication device.

The output information provision request unit may request to provide output information of the reproduction service information by accessing the network identification address of the reproduction service information via a network output service provider.

The output information receiving unit may receive reproduction service information and additional service information corresponding to the reproduction service information from the network output service provider.

The output information receiving unit may receive the reproduction service information and the additional service information corresponding to the reproduction service information and may receive output service information configuration information which indicates a configuration in which the reproduction service information and the additional service information are combined in the output service information.

The output service information provision unit may generate output service information by combining the received reproduction service information and the additional service information based on the output service information configuration information and may provide the generated output service information.

The mobile communication device may access the network device by using an Internet protocol (IP) address and a media access control (MAC) address of the network device.

The network output service information provider and a reproduction service provider for a mobile communication device may be the same.

The additional service information may be determined based on at least one of an attribute of reproduction service information, an attribute of a user of the mobile communication device, an attribute of a user of the network device, and an attribute of the network device.

The additional service information may include commercial and/or non-commercial advertising that is provided by a network output service information provider.

According to another aspect of the present invention, there is provided an apparatus for providing a network output service by using a mobile communication device, including: a network device selection unit selecting at least one network device from a plurality of registered network devices; a reproduction service information selection unit selecting at least one of a plurality of pieces of received reproduction service information for a mobile communication device; an output request unit requesting to output information comprising the selected reproduction service information and related additional service information, to the selected network device; and a reproduction service address information transmission unit transmitting network identification address information of the selected reproduction service information to the selected network device.

The mobile communication device may access the network device by using an Internet protocol (IP) address and a media access control (MAC) address of the network device.

The output request unit may generate output service information by combining reproduction service information provided by a reproduction service provider for a mobile communication device and additional service information provided by a network output service provider and may request to output the output service information.

According to another aspect of the present invention, there is provided a recording medium in which a program for executing a method of providing an output service of a network device is recorded, wherein the method includes: inputting an output request to at least one network device selected from a plurality of network devices registered in the mobile communication device; receiving network identification address information of reproduction service information selected by the mobile communication device; requesting to provide output information corresponding to the reproduction service information based on the network identification address information of the reproduction service information; receiving the output information comprising the reproduction service information and the additional service information; and providing output service information comprising a combination of the reproduction service information and the additional service information, based on the output information.

According to another aspect of the present invention, there is provided a recording medium in which a program for executing a method of providing a network output service by using a mobile communication device is recorded, wherein the method includes: selecting at least one network device from a plurality of registered network devices; selecting at least one of a plurality of pieces of received reproduction service information for a mobile communication device; requesting to output information comprising the selected reproduction service information and related additional service information, to the selected network device; and transmitting network identification address information of the selected reproduction service information to the selected network device.

According to another aspect of the present invention, there is provided a recording medium in which a program for executing a method of providing a network output service by using a mobile communication device is recorded, wherein the method includes: providing a reproduction service for a mobile communication device to the mobile communication device; inputting a request of providing output information corresponding to predetermined reproduction service information of a reproduction service for a mobile communication device; determining additional service information corresponding to the reproduction service information; and providing output information corresponding to the reproduction service information and the additional service information to a network device.

### BRIEF DESCRIPTION OF THE DRAWINGS

The above and other aspects of the present invention will become more apparent by describing in detail exemplary embodiments thereof with reference to the attached drawings in which:

FIG. 1A is a block diagram of an apparatus for providing an output service of a network device, according to an exemplary embodiment of the present invention;

FIG. 1B is a block diagram of an apparatus for providing a network output service by using a mobile communication device, according to an exemplary embodiment of the present invention;

FIG. 1C is a block diagram of an apparatus for providing a network output service by using a mobile communication device, according to another exemplary embodiment of the present invention;

FIG. 2 illustrates an environment for providing a network output service according to an exemplary embodiment of the present invention;

FIG. 3 illustrates a mobile communication device according to an exemplary embodiment of the present invention;

FIG. 4 illustrates a page in which reproduction service information is reproduced by a mobile communication device, according to an exemplary embodiment of the present invention;

FIG. 5 illustrates a page in which network output service information is output, according to an exemplary embodiment of the present invention;

FIG. 6 is a flowchart illustrating a method of providing an output service of a network device according to an exemplary embodiment of the present invention;

FIG. 7 is a flowchart illustrating a method of providing a network output service by using a mobile communication device, according to an exemplary embodiment of the present invention; and

FIG. 8 is a flowchart illustrating a method of providing a network output service by using a mobile communication device, according to another exemplary embodiment of the present invention.

### DETAILED DESCRIPTION EXEMPLARY EMBODIMENTS OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

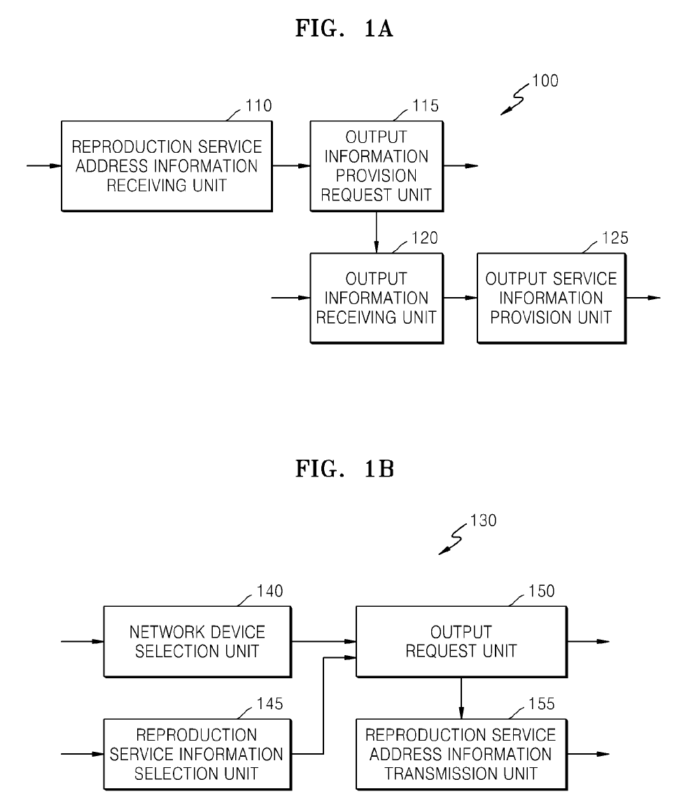

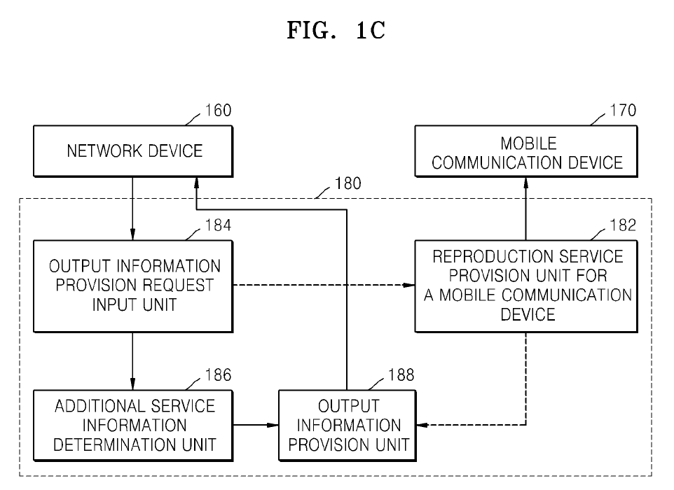

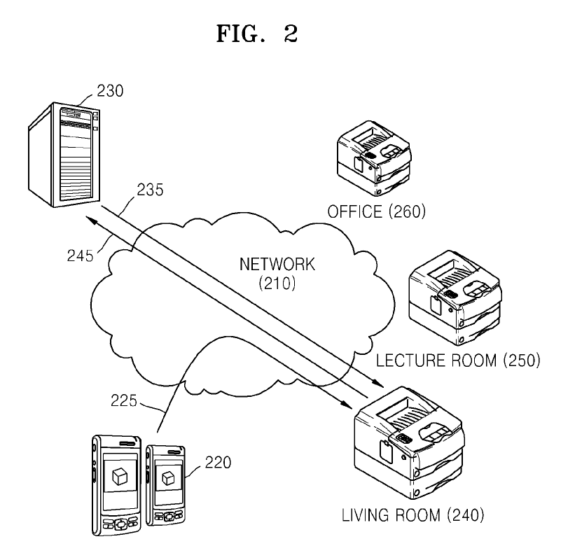

Hereinafter, a method and an apparatus for providing a network output service according to exemplary embodiments of the invention will be described with reference to FIGS. 1A through 8. First, for convenience of explanation, several terms are summarized.

A reproduction service for a mobile communication device is a kind of service that is restrictively displayed (reproduced) due to limited resources of the mobile communication device.

Output information refers to all information required to be output by a network output service provider together with a reproduction service according to a request to output a reproduction service for the mobile communication device.

An output service refers to contents including a reproduction service to be output and additional information corresponding to the reproduction service and which are inserted into a final output.

A network output service provider controls all output requests of a mobile communication device and a network device, converts an Internet service provided by an Internet service provider into a reproduction service for the mobile communication device or determines an additional service to be output together with a reproduction service in a network device, thereby determining information to be inserted in an output service.

An Internet service provider provides an Internet service to each entity over a network.

FIG. 1A is a block diagram of an apparatus 100 for providing an output service of a network device, according to an exemplary embodiment of the present invention.

Referring to FIG. 1, the apparatus 100 for providing an output service of a network device according to the current exemplary embodiment of the present invention includes a reproduction service address information receiving unit 110, an output information provision request unit 115, an output information receiving unit 120, and an output service information provision unit 125. The apparatus 100 may be installed in the network device.

When receiving an output request of a mobile communication device, the reproduction service address information receiving unit 110 receives network identification address information of reproduction service information from the mobile communication device. When a user of the mobile communication device selects at least one of a plurality of network devices registered in the mobile communication device, the mobile communication device may transmit network identification address information of reproduction service information to the selected network device.

The mobile communication device may access the network device by using an Internet protocol (IP) address and a media access control (MAC) address of the network device.

The output information provision request unit 115 requests to provide output information corresponding to reproduction service information based on network identification address information of reproduction service information that is received by the reproduction service address information receiving unit 110. The output information provision request unit 115 may request to provide output information to a network output service provider. According to an exemplary embodiment of the present invention, the output information provision request unit 115 may request to provide output information by accessing the network identification address of the reproduction address information via the network output service provider. Additionally, the output information provision request unit 115 may allow the output information receiving unit 120 to receive output information.

The output information receiving unit 120 receives output information including reproduction service information and additional service information from the network output information provider and outputs output information to the output service information provision unit 125.

The output information receiving unit 120 may receive output service configuration information together with reproduction service information and additional service information. Output service configuration information indicates a configuration in which reproduction service information and additional service information are combined in output service information. For example, a configuration in which reproduction service information and additional service information are disposed on output service information or are reproduced according to attributes of a reproduction service and an additional service and the like may be defined in output service information configuration information.

Additional service information may be determined based on at least one of an attribute of reproduction service information, an attribute of a mobile communication device user, an attribute of a network device user, and an attribute of the network device.

The output service information provision unit 125 provides output service information including a combination of reproduction service information and additional service information, based on output information that is received by the output information receiving unit 120. The output service information provision unit 125 may combine received reproduction service information and additional service information based on output service configuration information, thereby generating and providing output service information.

Although separately obtaining reproduction service information and additional service information, the output service information provision unit 125 may generate an output result of output service information by configuring reproduction service information and additional service information by using output service configuration information.

A reproduction service provider for a mobile communication device, providing reproduction service information for the mobile communication device, and a network output service information provider for providing an output service may be the same. On the other hand, the reproduction service provider for the mobile communication device and the network output service information provider may be different from each other.

FIG. 1B is a block diagram of an apparatus 130 for providing a network output service by using a mobile communication device, according to an exemplary embodiment of the present invention.

Referring to FIG. 1B, the apparatus 130 for providing a network output service by using a mobile communication device according to the current exemplary embodiment of the present invention includes a network device selection unit 140, a reproduction service information selection unit 145, an output request unit 150, and a reproduction service address information transmission unit 155. The apparatus 130 may be installed in the mobile communication device.

The network device selection unit 140 selects at least one of a plurality of network devices registered in the mobile communication device and an identifier of the device from the output request unit 150. The network devices registered in the mobile communication device may be identified by using an IP address and a MAC address.

The reproduction service information selection unit 145 selects at least one of a plurality of pieces of reproduction service information for the mobile communication device and outputs the selected reproduction service information to the output request unit 150. Additionally, the reproduction service information selection unit 145 may output network identification address information of network service information to the reproduction service address information transmission unit 155.

The output request unit 150 requests the network device selected by the network device selection unit 140 to output the reproduction service information that is selected by the reproduction service information selection unit 145. In this regard, according to an exemplary embodiment of the present invention, when there is a request from the mobile communication device to output a reproduction service, the network output service provider determines additional service information to be output together with a reproduction service. According to another exemplary embodiment of the present invention, the mobile communication device may also directly request the network device to output information including reproduction service information selected by the reproduction service information selection unit 145 and related additional service information.

The reproduction service address information transmission unit 155 transmits network identification address information of the reproduction service information that is selected by the network device together with an output request. Output of the reproduction service address information transmission unit 155 of the apparatus 130 for providing a network output service by using the mobile communication device may be the input of the reproduction service address information receiving unit 110 of the apparatus 100 for providing an output service of the network device.

FIG. 1C is a block diagram of an apparatus 180 for providing a network output service by using a mobile communication device, according to another exemplary embodiment of the present invention.

Referring to FIG. 1C, the apparatus 180 for providing a network output service by using a mobile communication device according to the current exemplary embodiment of the present invention includes a reproduction service provision unit 182 for a mobile communication device, an output information provision request input unit 184, an additional service information determination unit 186, and an output information provision unit 188. The apparatus 180 may be installed in a network output service provider or over a network server.

The reproduction service provision unit 182 for a mobile communication device provides a reproduction service for a mobile communication device 170. The reproduction service provision unit 182 for a mobile communication device may convert an Internet service provided by an Internet service provider into a reproduction service for a mobile communication device and may provide the reproduction service for the mobile communication device 170. When the Internet service provider and the network output service provider are the same, the reproduction service provision unit 182 for a mobile communication device may provide a reproduction service by using an Internet service provided by the network output service provider.

A request for providing output information corresponding to predetermined reproduction service information of a reproduction service for a mobile communication device that is selected by the mobile communication device 170, is input to the output information provision request input unit 184 from a network device 160 that is selected by the mobile communication device 170. When the network device 160 accesses a network identification address of reproduction service information, the output information provision request input unit 184 may recognize the access as a request of providing output information of reproduction service information.

According to an exemplary embodiment of the present invention, when there is an output information provision request, the output information provision request input unit 184 may inform an output information provision request to the reproduction service provider 182 for a mobile communication device and may provide corresponding reproduction service information to the output information provider 188.

The additional service information determination unit 186 determines additional service information corresponding to reproduction service information based on an output information provision request, and outputs additional service information to the output information provision unit 188. The additional service information determination unit 186 may further determine additional service information and output service information configuration information corresponding to reproduction service information and additional service information.

The additional service information determination unit 186 may determine additional service information based on at least one of an attribute of reproduction service information, an attribute of the user of the mobile communication device 170, an attribute of the user of the network device 160, and an attribute of the network device 160. Additional service information may include commercial/non-commercial advertising that is provided by a network output service information provider. Such advertising may be provided by the network output service information provider or the reproduction service provider for a mobile communication device. In addition, additional service information may be various information which the network output service information provider or the reproduction service provider for a mobile communication device wants to distribute, as well as advertising.

The output information provision unit 188 provides output information including reproduction service information and additional service information to the network device 160. Reproduction service information may be received by the reproduction service provision unit 182 for a mobile communication device and may also be obtained by an Internet service provider by using network identification address information of reproduction service information.

The output information provision unit 188 may provide output information including at least one of reproduction service information, additional service information, and output service information configuration information. According to an exemplary embodiment of the present invention, the output information provision unit 188 outputs reproduction service information, additional service information (and output service information configuration information) to the network device 160.

According to another exemplary embodiment of the present invention, the reproduction service provision unit 182 for a mobile communication device may output corresponding reproduction service information to the network device 160, and the output information provision unit 188 may output a related additional service (and output service information configuration information) to the network device 160.

According to an exemplary embodiment of the present invention, the network device 160 may include a network printer for outputting output service information and a device for generating and outputting software in which output service information is inserted, a data structure, etc.

As an example, when the network device 160 is a network printer and an output service for outputting documents is performed according to an exemplary embodiment of the present invention, at least one network printer as a network device may be connected to the mobile communication device. A network output request is input to the network output request input unit 184 from the network printer so as to output a document through a network. The output information provision unit 188 provides information required for printing combined reproduction service information and additional service information to the network printer.

A method of providing a network output service by using a mobile communication device according to exemplary embodiments of the present invention will now be described with reference to FIGS. 2 through 5.

FIG. 2 illustrates an environment for providing a network output service according to an exemplary embodiment of the present invention.

The environment in which a network output service is provided, according to the current exemplary embodiment of the present invention, includes a network 210, a wireless mobile phone 220 as a mobile communication device, a network output service provision device 230, and a plurality of network printers 240, 250, and 260 as network devices. Additionally, it is assumed that the environment is an environment in which a printing operation can be performed by using the network printers 240, 250, and 260 as network output devices.

The wireless mobile phone 220 may access an Internet service provider for providing various Internet sites through the Internet. In general, data communication speed and data processing speed for data transmission and reception are restricted in a mobile communication environment. Thus, the amount of information of a service that is provided by the Internet service provider to the wireless mobile phone 220 is limited as compared to a non-mobile communication environment, and in the environment, reproduction service information that can be smoothly reproduced by the wireless mobile phone 220 is transmitted. For example, reproduction service information may indicate pages and scripts of Internet sites and the like.

A user of the wireless mobile phone 220 selects a desired page to be output from among reproduction services provided in this manner and transmits a printing request 225 of the selected page to the network printer 240 that wants to print the page. The printing request 225 of the wireless mobile phone 220 may be an Internet address, such as a uniform resource locator (URL) of a page to be printed, or the like. The network printer 240 accesses an Internet address of a page requested to be printed by the wireless mobile phone 220 from the network output service provision device 230 and requests (245) output service information for printing.

The network output service provision device 230 provides (235) information on an output service as a result to be printed when there is a request of the wireless mobile phone 220 and the printer 240 to print information through the Internet. The network output service provision device 230 may be an independent output service information provider for smoothly providing a network output service in a mobile communication environment. Additionally, an Internet service provider for providing an Internet service to the wireless mobile phone 220 may provide a reproduction service on an Internet site reproduced by the wireless mobile phone 220 and an output service for output. As Internet service output service information, the page selected by the wireless mobile phone 220 and additional information which the reproduction service provider or the output service information provider wants to output, may be provided, and information on a configuration in which a reproduction service and additional information are combined, may be provided.

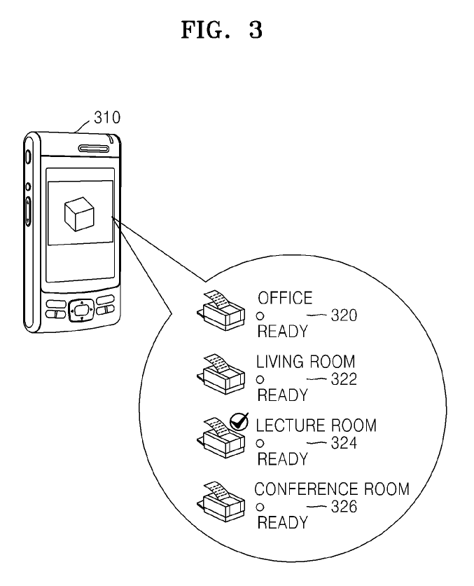

FIG. 3 illustrates a mobile communication device 310 according to an exemplary embodiment of the present invention.

Referring to FIG. 3, the mobile communication device 310 according to the current exemplary embodiment of the present invention is connected to at least one network device through a network. Network devices 320, 322, 324, and 326 which can access the mobile communication device 310 through the network are registered in the mobile communication device 310. The mobile communication device 310 selects at least one of the network devices 320, 322, 324, and 326, from among the accessible network devices 320, 322, 324, and 326 when it wants to output desired information through the network. A network device, for example, network device 324, which the mobile communication device 310 wants to use to output desired information, may be selected.

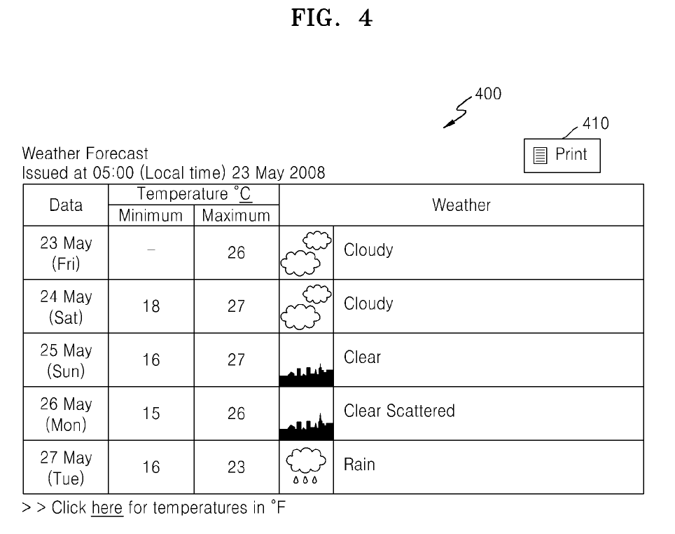

FIG. 4 illustrates a weather forecast page 400 in which reproduction service information is reproduced by a mobile communication device, according to an exemplary embodiment of the present invention.

The mobile communication device can display only a limited amount of information in one page due to limited resources and the network environment. When a user of the mobile communication device wants to print the weather forecast page 400 that is currently being reproduced, the user has only to click a printing button 410 on a right upper portion of the mobile communication device.

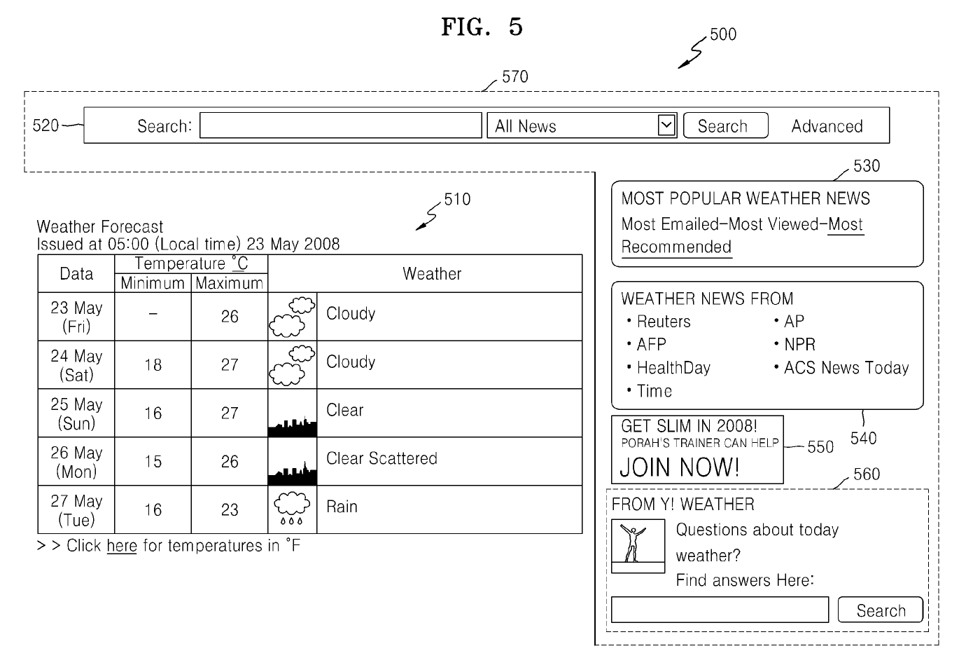

FIG. 5 illustrates an output page 500 in which network output service information is output, according to an exemplary embodiment of the present invention.

In connection with FIGS. 2 and 4, the output page 500 is an output result to be finally provided by the network printer 240 as output service information according to a request of the wireless mobile phone 220 or the network printer 240 for outputting a predetermined Internet site. The output page 500 includes a weather forecast page 510 of which output is requested by the wireless mobile phone 220, and other additional information 520, 530, 540, 550, 560, and 570.

The additional information 520, 530, 540, 550, 560, and 570 may be determined by a network output service provider or an Internet service provider. When the Internet service provider provides only limited web page information that can be reproduced by the wireless mobile phone 220 and there is a request of outputting a web page, the Internet service provider may determine in advance information to be provided to a user together with reproduced page information. On the other hand, the Internet service provider may provide only page information reproduced by the wireless mobile phone 220, and there may be a separate network output service provider which manages an output service.

Additional information may be determined based on a mobile communication user, a network environment, currently-output-requested information and the like. As an example of output service information including additional information, since the user has requested to output the weather forecast page 510, a news search window 520 in which weather forecast and information on all news can be searched, a weather forecast link window 530 including the most recent search, a weather forecast link window 540 for other sites, and another weather forecast search window 560 may be provided as additional information. Information related to a subject selected by the user and a commercial adverting window 550 may also be provided as additional information.

All of the additional information 520, 530, 540, 550, 560, and 570 is provided by the additional service information determination unit 186 so that its location and a display method and the like may be separately set and a set 570 of additional information may be determined in advance and may also be set in a consistent configuration.

The apparatus 100 for providing an output service of a network device illustrated in FIG. 1A may transmit configuration information on the selected weather forecast page 510, the additional information 520, 530, 540, 550, 560, and 570 and configuration information on the output resultant page to the network printer 240, and the network printer 240 may combine the resultant pages and output them.

According to another exemplary embodiment of the present invention, the apparatus 100 for providing an output service of a network device may transmit information on the completed output page 500 to the network printer 240, and the network printer 240 may also output information on the received output page 500.

Although, in the mobile communication device in which the amount of data that can be processed in real-time is limited, the Internet service provider cannot provide sufficient information or advertising, information or advertising may be inserted in a final output medium in which a better data processing environment is provided, by using a page blank and the like and may be provided to the user.

Although a printer as a network device and document printing as a network output operation have been described with reference to FIG. 5, when other wireless mobile phones or computers as network devices are connected and e-mail is received as network output, output service information including additional information by using the apparatus 100 for providing an output service of a network device illustrated in FIG. 1 may be e-mail.

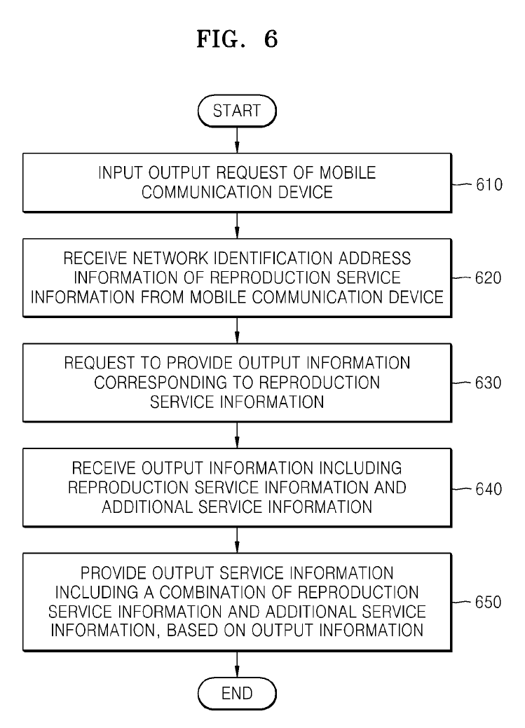

FIG. 6 is a flowchart illustrating a method of providing an output service of a network device, according to an exemplary embodiment of the present invention.

In operation 610, at least one network device is selected from a plurality of network devices registered in a mobile communication device and receives a request to output a predetermined reproduction service. The network device may be a printer, another mobile communication device, another terminal that can access a network, or the like.

In operation 620, network identification address information of selected reproduction service information is received from the mobile communication device.

In operation 630, providing of output information of reproduction service information is requested based on the network identification address information of the selected reproduction service information.

In operation 640, output information including the reproduction service information and additional service information is received.

In operation 650, output service information including a combination of the reproduction service information and the additional service information, is provided based on output information. The output service information including a combination of the reproduction service information and the additional service information, is finally output by the network device so that an output result in which more information than information that can be reproduced by the network device registered in the mobile communication device, can be provided to a user.

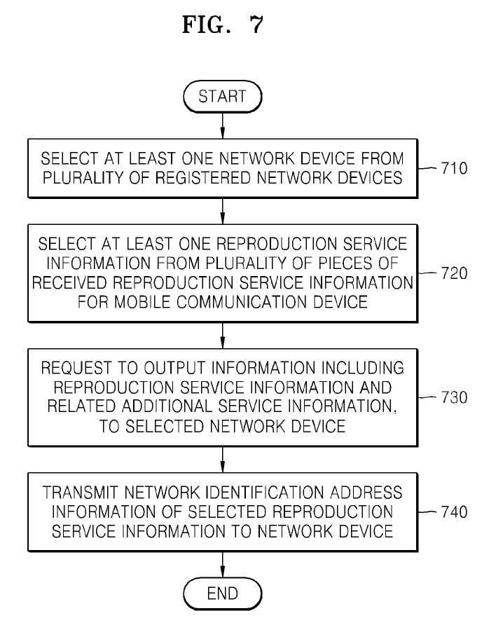

FIG. 7 is a flowchart illustrating a method of providing a network output service by using a mobile communication device, according to an exemplary embodiment of the present invention.

In operation 710, at least one network device is selected from a plurality of registered network devices. A button for selecting a network device is clicked on a screen of the mobile communication device so that a desired network device can be selected.

In operation 720, at least one of a plurality of pieces of reproduction service information is selected from received reproduction service information for the mobile communication device. The button is clicked on the screen of the mobile communication device so that reproduction service information to be output can be selected. In general, due to limited resources of the mobile communication device, a comparatively limited amount of data is registered in a reproduction service for the mobile communication device.

In operation 730, outputting of information including the selected reproduction service information and related additional service information, is requested from the selected network device. The network device may output the information including the selected reproduction service information and the related additional information, only according to a request to output reproduction service information by the mobile communication device.

In operation 740, network identification address information of the selected reproduction service information is transmitted to the network device.

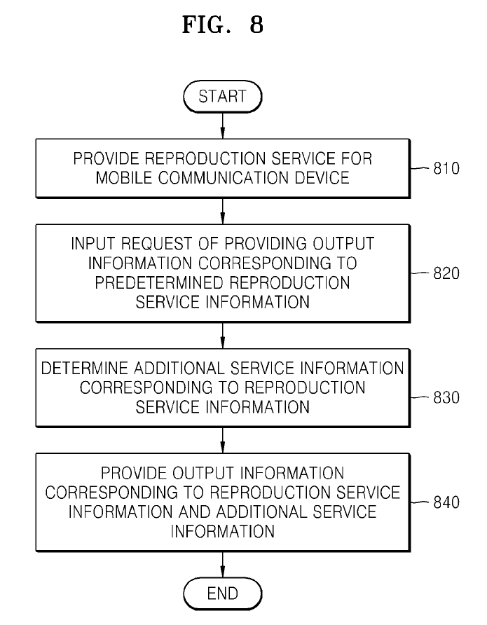

FIG. 8 is a flowchart illustrating a method of providing a network output service by using a mobile communication device, according to another exemplary embodiment of the present invention.

In operation 810, a reproduction service for a mobile communication device is provided to the mobile communication device.

In operation 820, a request of providing output information of predetermined reproduction service information from a plurality of reproduction services for the mobile communication device, selected by the mobile communication device, is input by the network device selected by the mobile communication device.

In operation 830, additional service information corresponding to the reproduction service information is determined. Additional service information may be determined based on at least one of an attribute of the reproduction service information, an attribute of a user of the mobile communication device, an attribute of a network device user, and an attribute of the network device.

In operation 840, output information including the reproduction service information and the additional service information is provided to the network device. The output information may include the reproduction service information, the additional service information, and output service information configuration information. The output service information configuration information includes information on a configuration in which reproduction service information and additional service information are arranged and displayed on an output service.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

The invention can also be embodied as computer readable codes on a computer readable transmission medium which may include carrier waves (such as data transmission through the Internet).

In the method and apparatus for providing a network output service according to the present invention, an output service in which information to be provided to a user by using a mobile communication device and additional information are registered, can be provided to the user. An output service in a format of a reproduction service provided to the user can be provided. Since additional information that cannot be reproduced by the mobile communication device due to limited resources of the mobile communication device can be provided to the user by using the output service, a demand of the user who wants more information can be satisfied and the effect of obtaining profits by advertising on an output medium can be obtained.

Furthermore, since the user can perform an output operation at a desired location by using the network device that can access the mobile communication device, even if the user performs an operation in transit or at a place distant from an network output device by using the mobile communication device, the operation is completed and the user performs an output operation, the user can check a result for outputting the operation at a desired destination.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of providing a network output service of a network device, the method comprising:
receiving network identification address information of reproduction service information selected by a mobile communication device, based on an output request of the mobile communication device;
requesting to provide output information of the reproduction service information based on the network identification address information of the reproduction service information;
receiving the output information comprising the reproduction service information and additional service information; and
providing output service information comprising a combination of the reproduction service information and the additional service information, based on the output information.

2. The method of claim 1, wherein the receiving of network identification address information of reproduction service information comprises:
inputting an output request to the network device; and
receiving the network identification address information of the reproduction service information selected by the mobile communication device,
wherein the network device is selected from among at least one network device registered in the mobile communication device.

3. The method of claim 1, wherein the requesting to provide output information comprises requesting to provide output information corresponding to the reproduction service information by accessing a network identification address of the reproduction service information via a network output service provider.

4. The method of claim 3, wherein the receiving of output information comprises receiving the reproduction service information and the additional service information corresponding to the reproduction service information from the network output service provider.

5. The method of claim 1, wherein the receiving of output information comprises:
receiving the reproduction service information and additional service information corresponding to the reproduction service information; and
receiving the output service configuration information which indicates a configuration in which the reproduction service information and the additional service information are combined in the output service information.

6. The method of claim 5, wherein the providing of output service information comprises:
generating output service information by combining the received reproduction service information and the additional service information based on the output service configuration information; and
providing the generated output service information.

7. The method of claim 1, wherein the mobile communication device accesses the network device by using an Internet protocol (IP) address and a media access control (MAC) address of the network device.

8. The method of claim 3, wherein the network output service information provider and a reproduction service provider for a mobile communication device are the same.

9. The method of claim 1, wherein the additional service information is determined based on at least one of an attribute of the reproduction service information, an attribute of a user of the mobile communication device, an attribute of a user of the network device, and an attribute of the network device.

10. The method of claim 1, wherein, in the receiving of additional service information, the additional service information comprises commercial and/or non-commercial advertising that is provided by a network output service information provider.

11. A method of providing a network output service by using a mobile communication device, the method comprising:
selecting at least one network device from a plurality of registered network devices;
selecting at least one of a plurality of pieces of received reproduction service information for the mobile communication device;
requesting to output information comprising the at least one selected reproduction service information and related additional service information, to the at least one selected network device; and
transmitting network identification address information of the selected reproduction service information to the at least one selected network device.

12. The method of claim 11, wherein the mobile communication device accesses the network device by using an Internet protocol (IP) address and a media access control (MAC) address of the network device.

13. The method of claim 11, wherein the requesting to output information comprises generating output service information by combining reproduction service information provided by a reproduction service provider for the mobile communication device and additional service information provided by a network output service provider and requesting to output the output service information.

14. An apparatus for providing a network output service by using a mobile communication device, the apparatus comprising:
a reproduction service provision unit for a mobile communication device, which provides a reproduction service for the mobile communication device to the mobile communication device;
an output information provision request input unit to which a request to provide output information corresponding to predetermined reproduction service information of the reproduction service for a mobile communication device selected by the mobile communication device, is input from the network device selected by the mobile communication device;
an additional service information determination unit which determines additional service information corresponding to the reproduction service information; and
an output information provision unit which provides output information comprising the reproduction service information and the additional service information to the network device.

15. The apparatus of claim 14, wherein a request of providing output information corresponding to reproduction service information is input to the output information provision request input unit when the network device accesses a network identification address of the predetermined reproduction service information.

16. The apparatus of claim 14, wherein the additional service information determination unit further determines output service configuration information on a configuration in which the reproduction service information and the additional service information are combined in output service information, and the output information provision unit provides output information comprising the reproduction service information, the additional service information, and the output service configuration information.

17. The apparatus of claim 14, wherein the additional service information determination unit determines the additional service information based on at least one of an attribute of the reproduction service information, an attribute of a user of the mobile communication device, an attribute of a user of the network device, and an attribute of the network device.

18. The apparatus of claim 14, wherein, in the output information provision unit, a reproduction service provider for a mobile communication device and a network output service information provider are the same.

19. The apparatus of claim 14, wherein the additional service information comprises commercial and/or non-commercial advertising that is provided by a network output service information provider.

20. An apparatus for providing an output service of a network device, comprising:
a reproduction service address information receiving unit which receives network identification address information of reproduction service information selected by a mobile communication device, based on an output request of the mobile communication device;
an output information provision request unit which requests to provide output information corresponding to the reproduction service information based on the network identification address information of the reproduction service information;
an output information receiving unit which receives the output information comprising the reproduction service information and additional service information; and
an output service information provision unit which provides output service information comprising a combination of the reproduction service information and the additional service information, based on the output information.

21. The apparatus of claim 20, wherein the reproduction service address information receiving unit receives an output request input to at least one network device selected from a plurality of network devices registered in the mobile communication device and receives network identification address information of reproduction service information selected by the mobile communication device.

22. The apparatus of claim 20, wherein the output information provision request unit requests to provide output information of the reproduction service information by accessing the network identification address of the reproduction service information via a network output service provider.

23. The apparatus of claim 22, wherein the output information receiving unit receives reproduction service information and additional service information corresponding to the reproduction service information from the network output service provider.

24. The apparatus of claim 20, wherein the output information receiving unit receives the reproduction service information and the additional service information corresponding to the reproduction service information and receives output service configuration information which indicates a configuration in which the reproduction service information and the additional service information are combined in the output service information.

25. The apparatus of claim 23, wherein the output service information provision unit generates output service information by combining the received reproduction service information and the additional service information based on the output service configuration information and provides the generated output service information.

26. The apparatus of claim 20, wherein the mobile communication device accesses the network device by using an Internet protocol (IP) address and a media access control (MAC) address of the network device.

27. The apparatus of claim 22, wherein the network output service provider and a reproduction service provider for a mobile communication device are the same.

28. The apparatus of claim 20, wherein the additional service information is determined based on at least one of an attribute of reproduction service information, an attribute of a user of the mobile communication device, an attribute of a user of the network device, and an attribute of the network device.

29. The apparatus of claim 20, wherein the additional service information comprises commercial and/or non-commercial advertising that is provided by a network output service information provider.

30. An apparatus for providing a network output service by using a mobile communication device, comprising:
a network device selection unit which selects at least one network device from a plurality of registered network devices;
a reproduction service information selection unit which selects at least one of a plurality of pieces of received reproduction service information for the mobile communication device;
an output request unit which requests to output information comprising the at least one selected reproduction service information and related additional service information, to the selected network device; and
a reproduction service address information transmission unit which transmits network identification address information of the at least one selected reproduction service information to the selected network device.

31. The apparatus of claim 30, wherein the mobile communication device accesses the network device by using an Internet protocol (IP) address and a media access control (MAC) address of the network device.

32. The apparatus of claim 30, wherein the output request unit generates output service information by combining reproduction service information provided by a reproduction service provider for a mobile communication device and additional service information provided by a network output service provider and requests to output the output service information.

33. A computer readable recording medium having embodied thereon a computer program for executing a method of providing an output service of a network device, wherein the method comprises:
inputting an output request to at least one network device selected from a plurality of network devices registered in the mobile communication device;
receiving network identification address information of reproduction service information selected by the mobile communication device;
requesting to provide output information corresponding to the reproduction service information based on the network identification address information of the reproduction service information;
receiving the output information comprising the reproduction service information and the additional service information; and
providing output service information comprising a combination of the reproduction service information and the additional service information, based on the output information.

34. A computer readable recording medium having embodied thereon a computer program for executing a method of providing a network output service by using a mobile communication device, wherein the method comprises:
selecting at least one network device from a plurality of registered network devices;
selecting at least one of a plurality of pieces of received reproduction service information for a mobile communication device;
requesting to output information comprising the selected reproduction service information and related additional service information, to the selected network device; and
transmitting network identification address information of the selected reproduction service information to the selected network device.

35. A computer readable recording medium having embodied thereon a computer program for executing a method of providing a network output service by using a mobile communication device, wherein the method comprises:
providing a reproduction service for a mobile communication device to the mobile communication device;
inputting a request of providing output information corresponding to predetermined reproduction service information of a reproduction service for a mobile communication device;
determining additional service information corresponding to the reproduction service information; and
providing output information corresponding to the reproduction service information and the additional service information to a network device.
